(19) United States
(12) Patent Application Publication
(10) Pub. No.: US 2005/0157892 A1
(43) Pub. Date: Jul. 21, 2005

(54) Cabled & wireless dual-purpose microphone

(76) Inventor: Cheng-Shun Chiu, Panchiao City (TW)

Correspondence Address: Cheng-Shun Chiu, PO Box 82-144, Taipei, TW

(21) Appl. No.: 10/758,089

(22) Filed: Jan. 16, 2004

(51) Int. Cl. H04R 3/00

(52) U.S. Cl. 381/111; 381/113

(57) ABSTRACT

A cabled and wireless dual-purpose microphone is comprised of a receiver containing a transmission baseboard, the baseboard connected to a receiving unit and to Type 1 adapter, a wireless connector containing a casing to accommodate a battery source, a primary end of the casing connected to Type 2 adapter relatively connected to Type 1 adapter in the receiver, an antenna being connected to a conductor; and a cabled adapter with its primary end provided with Type 2 adapter relatively connected to Type 1 of the receiver, Type 2 adapter being connected to a conductor, and a connector being connected to a terminal of the conductor to plug in an audio input of a sound system to function as a cabled, or a wireless microphone or to permit continue use by immediately switching to cabled microphone in the absence of voltage from the battery.

### BACKGROUND OF THE INVENTION

(a) Technical Field of the Invention

The present invention is related to a cabled and wireless dual-purpose microphone, and more particularly, to one that allows its receiver to be connected to a wireless or a cabled adapter to become a wireless microphone or a cabled microphone.

(b) Description of the Prior Art

Microphones generally available in the market are either of cabled or wireless ones. For a cabled microphone, it takes a conductor to connect the microphone to a sound system for use. Whereas the long conductor makes the use of the microphone quite awkward, many users prefer the wireless microphone.

However, the wireless microphone operates on a built-in battery as the power source and usually the user will not bother to find out the remaining capacity of the battery, nor prepare any spare battery. Therefore, it is not unusual to find that the user has to stop singing right in the middle of a song due to the battery is running out of its capacity. While awaiting the replacement, the festival mood is spoiled. Furthermore, the wireless microphone is not functioning at where presents too much interference from the environment.

### SUMMARY OF THE INVENTION

The primary purpose of the present invention is to provide a cabled and wireless microphone that function as a cabled, or a wireless microphone or to permit continue use by switching to cabled microphone in the absence of voltage from the battery. To achieve the purpose, the present invention is comprised of a receiver provided with a transmission baseboard, the baseboard is connected to a receiving unit and to Type 1 adapter; a wireless adapter containing a casing to accommodate a battery source, a primary end of the casing connected to Type 2 adapter relatively connected to Type 1 adapter in the receiver, an antenna is connected to a conductor, and a cabled connector has its primary end provided with Type 2 adapter relatively connected to Type 1 adapter of the receiver, Type 2 adapter is connected to a conductor, and an connector is connected to a terminal of the conductor to plug in an audio input of a sound system.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIGS. 1A, 1B are schematic views of the components of the present invention.

FIG. 2 is a schematic view of the present invention used as a wireless microphone.

FIG. 3 is a schematic view of the present invention used as a cabled microphone.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

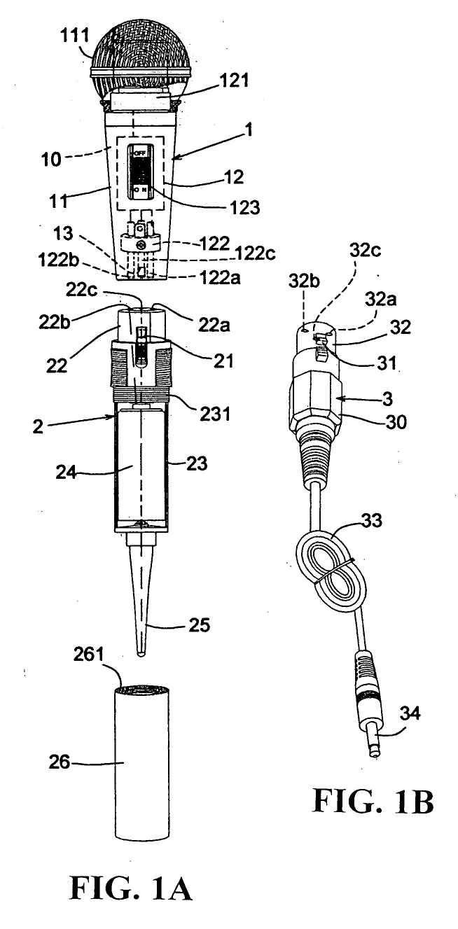

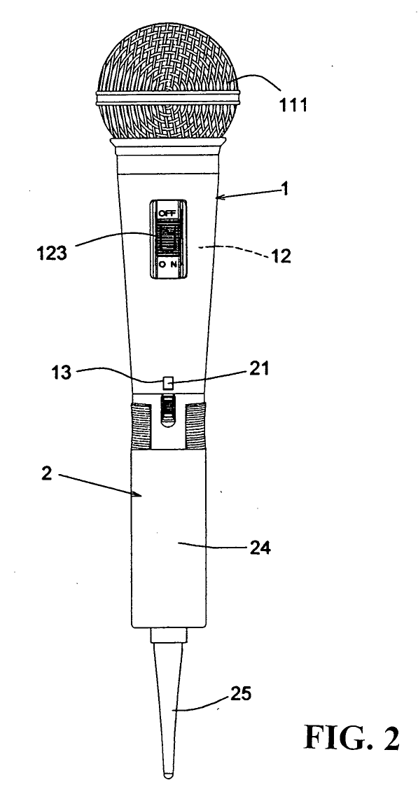

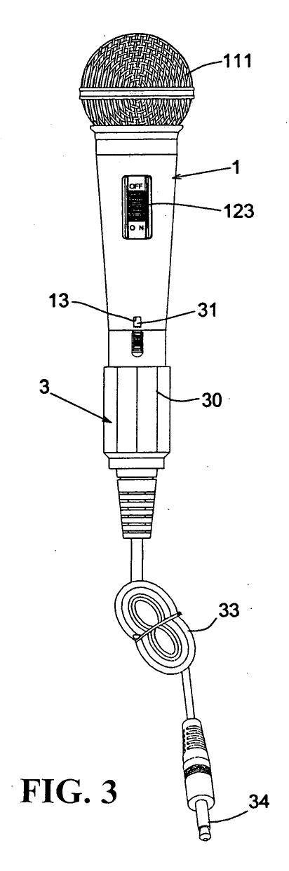

Referring to FIGS. 1A, 1B, 2, and 3, a preferred embodiment of the present invention related to a cabled and wireless dual-purpose microphone is essentially comprised of a receiver (1), a wireless connector (2) and a cabled connector (3) to function as a cabled, or a wireless microphone or to permit continue use by switching to cabled microphone in the absence of voltage from the battery.

As illustrated in FIGS. 1A and 1B, the receiver (1) includes a body (11) containing a chamber (10); and a transmission baseboard (12) disposed in the chamber (10) containing a receive unit (121) closer to a receiver area (111) of the body (11). The transmission baseboard (12) is connected to Type 1 adapter (122) for input from a power source and output of audio signal. The input circuit of the source of the power source is connected to an on/off switch (123).

One end of the body (11) of the receiver (1) contains a locking member (13) relatively connected to Type 2 locking member (21) provided on the wireless connector (2).or another Type 2 locking member (31) provided on the cabled connector (3). Both of Type 2 locking members (21, 31) respectively provided to the wireless connector (2) and the cabled connector (3) each related to an elastic hook engage Type 1 locking member (13) provided in recessed on the body (11) of the receiver (1). However, the prevent invention does not restrict the form of Type 1 (13) or Type 2 locking member (21,31).

Type 1 adapter (122) of the transmission baseboard (12) provided in the receiver (1) includes a pair of input terminals (122a, 122b) and an audio output terminal (122c). Both Type 2 adapters (22,32) respectively provided to the wireless connector (2) and a cabled connector (3) are each contain a pair of power output terminals [(22a, 22b)(32a, 32b)] and an audio input terminal (22c, 32c) for Type 1 adapter (122) to relatively connected to those Type 2 adapters (22, 32) to execute power and signal transnission.

The wireless connector (2) contains a battery cabinet (23) to contain a batter or multiple batteries (24). With the battery (24) placed in the battery cabinet (23), both poles respectively connected to the pair of the power source output terminals (22a, 22b) from Type 2 adapter (22). The wireless connector (2) contains an antenna (25) connected to the input terminal (22c) of the audio input of Type 2 adapter (22) for external transmission. Signals of the audio source from the transmission baseboard (12) are received by a sound system (not illustrated) after the receiving, oscillation and amplification.

The wireless connector (2) further includes a battery lid (26) to cover up the battery cabinet (23) and to secure the battery (24) in the battery cabinet (23). The battery lid (26) may be made in a cylindrical form with it top provided with an internal threaded (261) to engage to an external thread (231) provided to the battery cabinet (23).

The cabled connector (3) includes a body (30) with one end provided with Type 2 adapter (32) relatively connected to Type 1 adapter (12) of the receiver (1), and Type 2 adapter (32) is connected with a conductor (33) with its terminal connected to a connector (34) to plug into the audio input of the sound system.

The wireless and cabled dual-purpose microphone disclosed in the present invention is innovative and practical for that when it functions as a wireless microphone since the receiver (1) is adapted with a wireless connector (2) depending on the use or as preferred by the user; or as a cabled microphone when adapted with a cabled connector (3). Furthermore, when in the course of the use of the wireless microphone and it is found that the voltage of the battery is not sufficient, the user may immediately switch to the cabled connector (3) to continue the status of use without interrupting the performance or conversation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1. A cabled and wireless dual-purpose microphone is comprised of a receiver, a wireless connector and a cabled connector, the receiver being provided with a transmission baseboard connected to a receiving unit, and to Type 1 adapter; the wireless connector including a casing to accommodate a battery source with the primary end of the casing connected to Type 2 adapter relatively connected to Type 1 adapter connected to the receiver, and an antenna being provided to the battery source; and the cabled connector with its primary end provided with Type 2 adapter relatively connected to Type 1 adapter of the receiver, a conductor being connected to Type 2 adapter, a connector being adapted to the terminal of the conductor to plug into audio input of a sound system.

2. A cabled and wireless dual-purpose microphone as claimed in claim 1, wherein, the receiver includes a body containing a chamber, a transmission baseboard in the chamber containing a receiving unit provided at where close to the audio receiving area of the body; the transmission baseboard being connected to Type 1 adapter for input of power source and output of audio signal; and the input circuit of the power source being connected to an On/Off switch.

3. A cabled and wireless dual-purpose microphone as claimed in claim 1, wherein, one end of the receiver contains Type 1 locking member relatively connected to Type 2 locking member provided to the wireless or cabled connector.
